(19) United States
(12) Patent Application Publication
(10) Pub. No.: US 2010/0034632 A1
(43) Pub. Date: Feb. 11, 2010

(54) METHOD AND APPARATUS FOR ROTATING HEAVY WEIGHT OBJECT

(75) Inventor: Dong-Su PARK, Daejeon (KR)

Correspondence Address: LRK Patent Firm, 1952 Gallows Rd Suite 200, Vienna, VA, 22182, US

(73) Assignee: KOREA ELECTRIC POWER CORPORATION, Daejeon (KR)

(21) Appl. No.: 12/260,226

(22) Filed: Oct. 29, 2008

(30) Foreign Application Priority Data
Aug. 7, 2008 (KR) 10-2008-0077338

(51) Int. Cl. B27B 31/04

(52) U.S. Cl. 414/781

(57) ABSTRACT

Disclosed is a method and apparatus for rotating a heavy weight object by coincidence of centers of gravity. The apparatus includes a fixing frame unit to fix the weight object; a weight object rotating unit accommodating the weight object, including a rotatable semicircular frame, and connected to the fixing frame unit; a weight object/frame support unit formed under the semicircular frame to support the semicircular frame; and a motor/gear unit formed between the weight object rotating unit and the weight object/frame support unit to rotate the weight object rotating unit using bearings. The apparatus rotates the weight object even when the minimum force is applied to the weight object through the weight object rotating unit, has a minimized radius of rotation, and secures the safety, thus being applied to a production and assembly line in a narrow space to produce weight objects or a structural test building.

### CROSS-REFERENCE TO RELATED APPLICATION

The benefit of priority is claimed to Republic of Korea patent application number 10-2008-0077338, filed Aug. 7, 2008, which is incorporated by reference herein.

### BACKGROUND

1. Field of the Invention

The present invention relates to a method and apparatus for rotating a heavy weight object, and more particularly to a method and apparatus, which effectively rotates a heavy weight object using a principle, in which the minimum force is applied to the heavy weight object in case that the heavy weight object is manufactured differing from loading conditions in a structural test and is then rotated to satisfy testing conditions or as needed according to an assembly process.

2. Description of the Related Art

In general, weight objects are difficult to transfer or rotate due to their heavy weight and have a possibility of danger all the time, and thus can be transferred and rotated using a crane or a special apparatus. As a typical example of heavy weight objects, there is a specimen manufactured in a structural test.

The specimen is generally manufactured and assembled differing from loading conditions in a structural test for the convenience of concrete casting and assembly, and then requires rotation to satisfy testing conditions. In order to rotate the specimen, the specimen has been rotated so far using a crane used at the outside of a building or a special rotating apparatus.

In case that the specimen is rotated using the crane, the crane may drop the specimen on the bottom and damage the specimen, or a process of rolling the specimen to rotate the specimen may cause an unexpected safety accident frequently. Therefore, instead of the problem cane, a large forklift having a remodeled front part is used to rotate the specimen.

However, the remodeled apparatus is expensive, and requires an excessively large radius of rotation, when the specimen is rotated in a structural test building having a narrow space, thus being incapable of easily rotating the specimen.

### SUMMARY

Therefore, the present invention has been made in view of the above problems, and it is an object of the present invention to provide an apparatus for rotating a heavy weight object, the structure of which is effectively improved to rotate the heavy weight object by the minimum force, as a substitute for a conventional crane and remodeled forklift, and a method for rotating a heavy weight object, in which the minimum force is applied to the heavy weight object using the above structure to rotate the heavy weight object.

It is another object of the present invention to provide an apparatus for rotating a heavy weight object, the structure of which is improved to reduce a radius of rotation such that the apparatus can be easily used even in a narrow space, and a method for rotating a heavy weight object, in which the object is rotated at a small radius of rotation using the above structure.

In accordance with an aspect of the present invention, the above and other objects can be accomplished by the provision of an apparatus for rotating a heavy weight object comprising a fixing frame unit to fix the weight object; a weight object rotating unit accommodating the weight object, including a rotatable semicircular frame, and connected to the fixing frame unit; a weight object/frame support unit formed under the semicircular frame to support the semicircular frame; and a motor/gear unit formed between the weight object rotating unit and the weight object/frame support unit to rotate the weight object rotating unit using bearings.

The weight object rotating unit may include an inner semicircular frame supporting the weight object at the inside to rotate the weight object; an outer semicircular frame linearly contacting the outer surface of the inner semicircular frame through the medium of the bearings; and support frames having varied lengths provided between the inner semicircular frame and the fixing frame unit, and connected to the fixing frame unit.

In accordance with another aspect of the present invention, there is provided a method for manufacturing an apparatus for rotating a heavy weight object, comprising preparing a fixing frame unit to fix the weight object; preparing a weight object rotating unit accommodating the weight object, including a rotatable semicircular frame, and connecting the weight object rotating unit to the fixing frame unit; preparing a weight object/frame support unit formed under the semicircular frame, and supporting the semicircular frame through weight object/frame support unit; and preparing a motor/gear unit formed between the weight object rotating unit and the weight object/frame support unit, and rotating the weight object rotating unit using bearings through the motor/gear unit.

The preparation of the weight object rotating unit may include supporting the weight object at the inside through an inner semicircular frame to rotate the weight object; causing an outer semicircular frame to linearly contact the outer surface of the inner semicircular frame through the medium of the bearings; and connecting support frames having varied lengths, provided between the inner semicircular frame and the fixing frame unit, to the fixing frame unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view illustrating an apparatus for rotating a heavy weight object in accordance with one embodiment of the present invention;

FIG. 2 is a rear view illustrating the apparatus in accordance with one embodiment of the present invention in a state in which a weight object rotating unit and a weight object are rotated by a motor/gear unit;

FIG. 3 is a top view illustrating the apparatus in accordance with one embodiment of the present invention;

FIG. 4 is a view illustrating subsidiary frames provided based on the size of a weight object in accordance with one embodiment of the present invention;

FIG. 5 is a view illustrating the relation between a semicircular frame and bearings in accordance with one embodiment of the present invention; and

FIG. 6 is a photograph of a real apparatus for rotating a heavy weight object.

### DETAILED DESCRIPTION

A detailed description of the present invention, which will be described following, is a specific embodiment of the present invention, an example of which is illustrated in the accompanying drawings. This embodiment will be described in detail such that those skilled in the art will appreciate the present invention. It will be understood that various embodiments of the present invention differ from each other, but are not mutually exclusive. For example, specific shapes, structure, features, which are described herein, may be embodied into another embodiment, without departing from the scope and spirit of the invention. Further, it will be understood that positions or dispositions of respective elements in the disclosed embodiment may be modified, without departing from the scope and spirit of the invention. Thus, the detailed description of the present invention, which will be described following, is not limitative, but the scope of the present invention is limited only by the accompanying claims and their equivalents. In the drawings, similar reference numerals represent the same or similar functions.

Now, preferred embodiments of the present invention will be described in detail with reference to the annexed drawings such that those skilled in the art will easily embody the present invention.

It will be understood that heavy weight objects, which will be described following, include in a narrow view specimens required in a structural test or products obtained by an assembly process in a production and assembly line, and include in a wide view objects intended to be rotated using a crane or a forklift.

Configuration of Rotating Apparatus

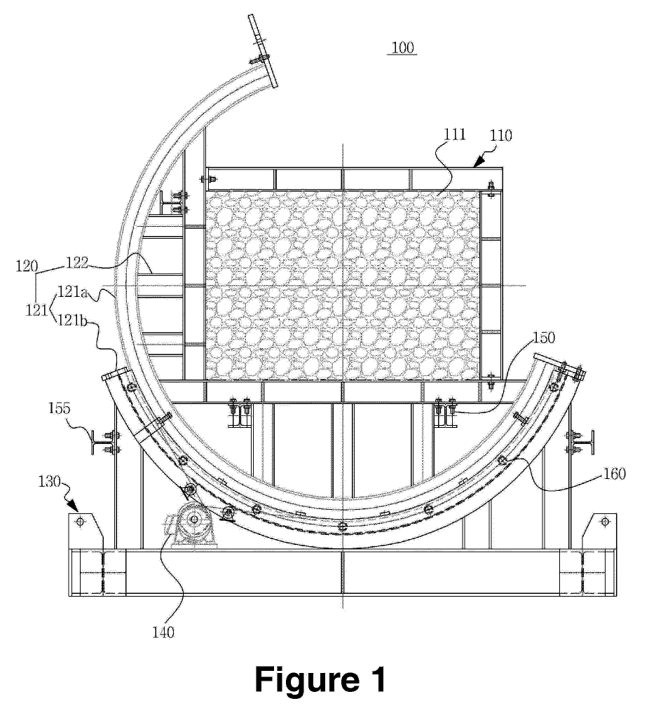

FIG. 1 is a front view illustrating an apparatus for rotating a heavy weight object in accordance with one embodiment of the present invention.

With reference to FIG. 1, an apparatus 100 for rotating a heavy weight object in accordance with one embodiment of the present invention includes a fixing frame unit 110, a weight object rotating unit 120, a weight object/frame support unit 130, a motor/gear unit 140, first reinforcing frames 150, and second reinforcing frames 155.

First, the fixing frame unit 110 serves to fix a weight object 111, which is a target to be rotated, and is adhered to at least one surface of the weight object 111. Although this embodiment describes the weight object 111 having a rectangular shape, the weight object 111 is not limited to the rectangular shape but may have various shapes. The fixing frame unit 110 is adhered to the weight object 111, and thus is capable of fixing the weight object 111.

Further, the fixing frame unit 110 in accordance with the present invention is made of various materials according to the weight of the weight object 111, and preferably made of a hard material, which is not damaged by the weight of the weight object 111. For example, the fixing frame unit 110 is made of a material having a high durability, such as metal, iron, or aluminum. Here, a plurality of fixing frame units 110 may be assembled or connected by connectors, or be formed integrally.

The weight object rotating unit 120 in accordance with the present invention includes a semicircular frame 121, which accommodates the weight object 111 fixed to the fixing frame 110, and support frames 122, which connect the semicircular frame 121 and the fixing frame unit 110 to support the weight object 111. The semicircular frame 121 in accordance with the present invention includes an inner semicircular frame 121a, which supports the weight object 111 at the inside to rotate the weight object 111, and an outer semicircular frame 121b, which linearly contacts the outer surface of the inner semicircular frame 121a through the medium of bearings 160. The semicircular frame 121 has a semicircular shape such that the semicircular frame 121 can be rotated together with the rotation of the weight object 111 when the weight object 111 is rotated.

The support frames 122 in accordance with the present invention are formed between the inner semicircular frame 121a and the fixing frame unit 110, and serve to support the fixing frame unit 110. Particularly, the support frames 122 serve as connection lines between the fixing frame unit 110 and the semicircular frame 121 such that the force applied from the weight object 111 to the fixing frame unit 110 can be transmitted to the semicircular frame 121. The support frames 122 may have varied lengths according to the sizes of the weight object 111 and the fixing frame unit 110 or the intensity of the applied force.

Since such a weight object rotating unit 120 ultimately serves to effectively rotate the weight object 111 by the minimum force, the center of the inner semicircular frame 121a and the center of gravity of the weight object 111 coincide with each other, thus being capable of rotating the weight object 111. That is, in the weight object rotating unit 120 of the present invention, the plural support frames 122 having varied lengths are provided between the inner semicircular frame 121a and the fixing frame unit 110 so as to include the force of the fixing frame unit 110 loaded with the center of gravity of the weight object 111 in the center of the inner semicircular frame 121a, and thereby the center of gravity of the weight object 111 can coincide with the center of the inner semicircular frame 121a.

The weight object/frame support unit 130 in accordance with the present invention is formed under the semicircular frame 121 such that a portion of the semicircular frame 121 is seated on the weight object/frame support unit 130, and thus serves to support the semicircular frame 121. The weight object/frame support unit 130 is made of a material, which holds up weights of the weight object 111, the fixing frame unit 110, the semicircular frame 121, the support frames 122, etc. That is, the weight object/frame support unit 130 is made of a material having a high durability, such as metal, iron, or aluminum, according to the weights.

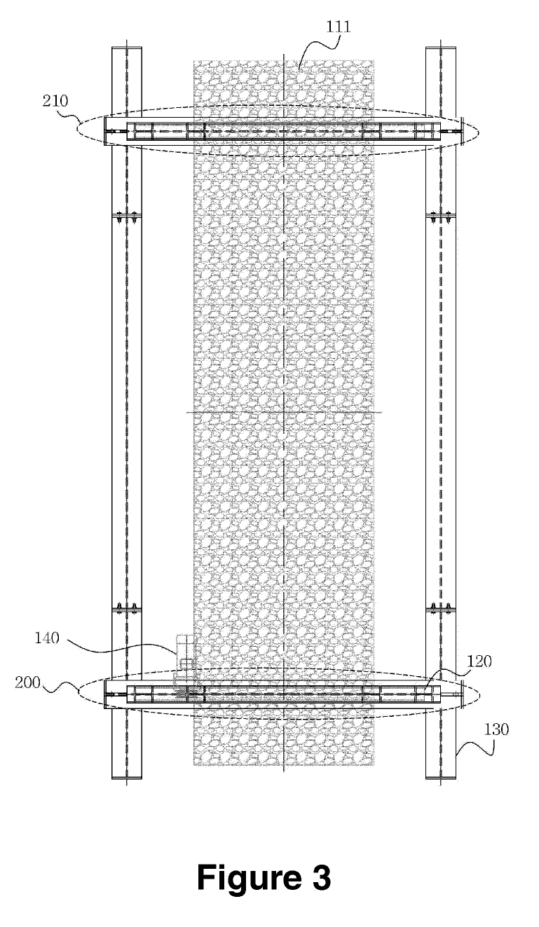

Prior to the description of the motor/gear unit 140, the first reinforcing frames 150 and the second reinforcing frames 155 will be described. That is, the first reinforcing frames 150 serve to connect a first shaft and a second shaft such that the two shafts can be rotated simultaneously to prevent the inner semicircular frame 121b from being separated from the bearings 160. Here, each of the first shaft and second shaft represents a structure including the fixing frame unit 110, the weight object rotating unit 120, and the weight object/frame support unit 130. The first shaft and the second shaft are shown in FIG. 3, which will be described later.

On the other hand, the second reinforcing frames 155 are formed on the weight object/frame support unit 130, and thus serve to connect the first shaft and the second shaft and thus support the weight object rotating unit 120.

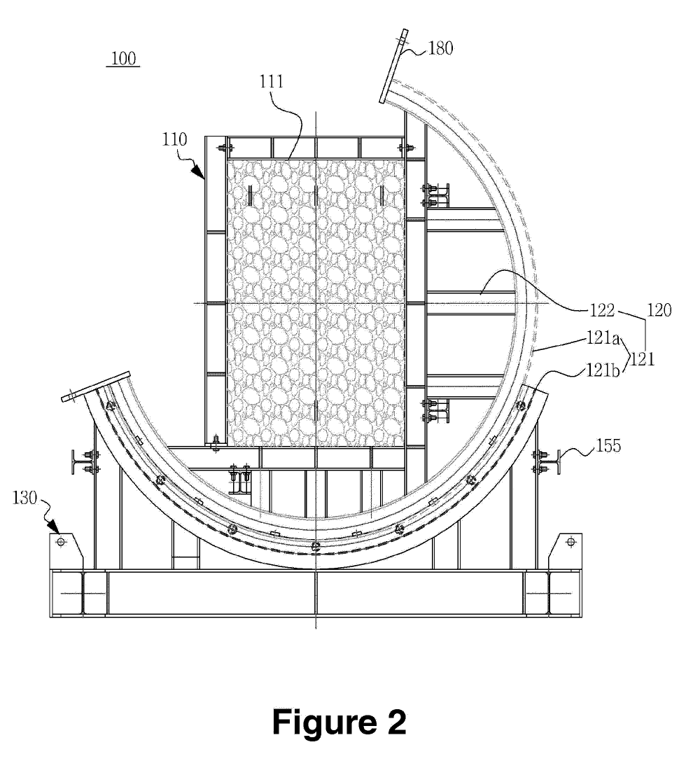

Finally, the motor/gear unit 140 in accordance with the present invention is formed between the weight object rotating unit 120 and the weight object/frame support unit 130, which were described above, and serves to rotate the weight object rotating unit 120 together with the fixed weight object 111 using the bearings 160. Hereinafter, the rotation of the weight object rotating unit 120 by the motor/gear unit 140 will be described in detail with reference to FIG. 2.

FIG. 2 is a rear view illustrating the apparatus in accordance with one embodiment of the present invention in a state in which the weight object rotating unit and the weight object are rotated by the motor/gear unit.

FIG. 2 illustrates a rotated result of the apparatus 100 of FIG. 1, viewed from the rear. With reference to FIG. 2, the motor/gear unit 140 in accordance with the embodiment of the present invention is provided with a chain (not shown) engaged with the bearings 160. Therefore, when the chain connected to the inner semicircular frame 121a is pulled using a rotating unit, for example a rotating unit of a motor, the inner semicircular frame 121a is slipped by the bearings 160 fixed to the outer semicircular frame 121b, and thus, the weight object rotating unit 120 including the weight object 111 are rotated at an angle of 90° on the upper surface of the weight object/frame support unit 130. Here, the rotating unit of an overhead crane is referred to as a unit, which can be used in a narrow laboratory, and the rotating unit is not limited to the overhead crane but may include any unit, which can pull the chain with a small force even in a narrow space.

Since the center of gravity of the weight object rotating unit 120 coincides with the center of gravity of the weight object 111, the weight object rotating unit 120 including the weight object 111 is easily rotated even when a small force is applied to the weight object rotating unit 120 by the chain.

Further, the apparatus 100 in accordance with the embodiment of the present invention further includes end supporters 180, which lift up the apparatus 100 to rotate the apparatus 100 as well as connect the inner semicircular frame 122a and the outer semicircular frame 122b after the rotation. The end supporters 180 are formed at regions, where ends of the inner semicircular frame 121a and outer semicircular frame 121b meet, and are fixed to the inner semicircular frame 121a and outer semicircular frame 121b using bolts and nuts.

FIG. 3 is a top view illustrating the apparatus in accordance with one embodiment of the present invention.

FIG. 3 illustrates the apparatus 100 viewed from the top, and includes a first shaft 200 and a second shaft 210.

The first shaft 200 and the second shaft 210 are formed close to both ends of the lower surface of the weight object 111 to support the weight object 111, and thus serve to maintain the safety of the weight object 111. Further, two weight object/frame support units 130, which are perpendicular to the longitudinal direction of the first shaft 200 and the second shaft 210, may be formed below the weight object 111. Here, the first shaft 200, the second shaft 210, and the two weight object/frame support units 130 are connected to each other. The motor/gear unit 140 is formed on the inside of the first shaft 200.

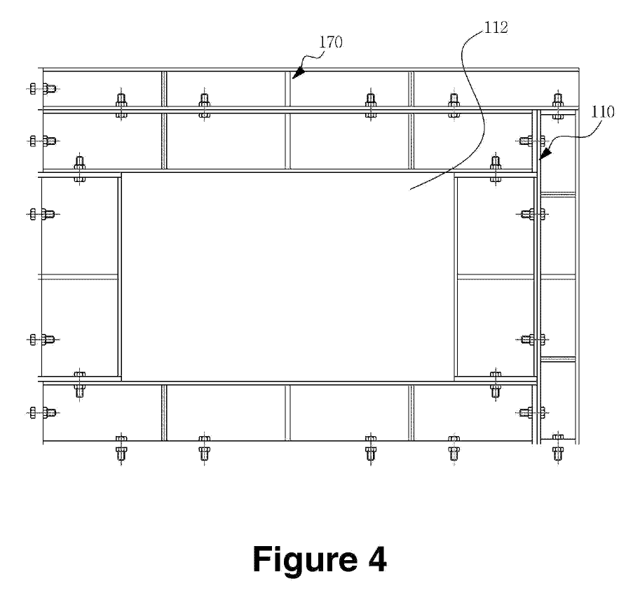

FIG. 4 is a view illustrating subsidiary frames 170 in accordance with one embodiment of the present invention, provided based on the size of a weight object.

FIG. 4 illustrates the relation among a weight object 112, the fixing frame units 110, and the subsidiary frames 170. In case that the weight object 112 has a larger size than that of the above-described weight object 111, a plurality of fixing frame units 110 are assembled using bolts or nuts and are adhered to the weight object 112, thus being capable of fixing the weight object.

The subsidiary frames 170 of the present invention serve to supplement the functions of the fixing frame units 110 such that the subsidiary frames 170 can stand the pressure of the weight object 112 applied to the fixing frame units 110. The plural subsidiary frames 170 are assembled, and are connected to the fixing frame units 110. These subsidiary frames 170 are configured such that the center of gravity of the weight object 112 coincides with the center of the semicircular frame 121, as shown in FIG. 1, and thus minimizes force required to rotate the weight object 112.

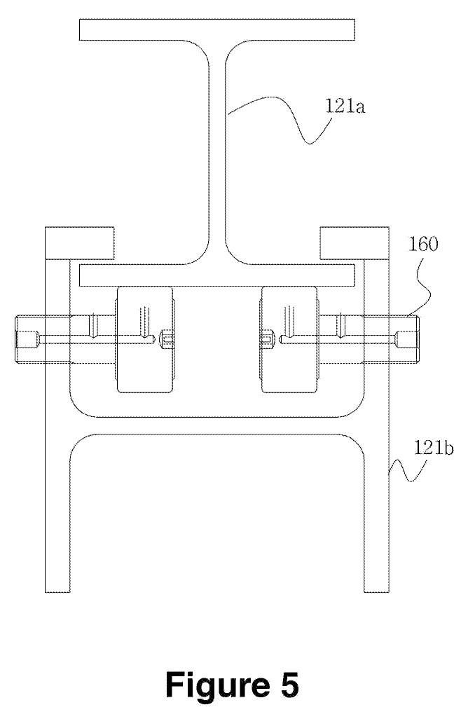

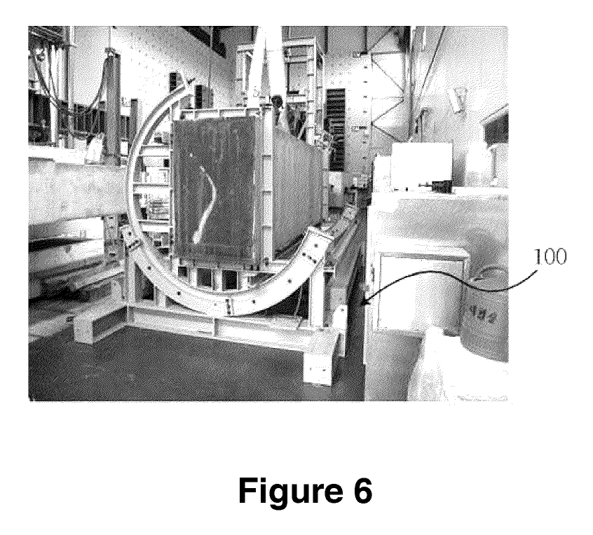

FIG. 5 is a view illustrating the relation between the semicircular frame 121 and the bearings 160 in accordance with one embodiment of the present invention, and FIG. 6 is a photograph of a real apparatus for rotating a heavy weight object.

With reference to FIG. 5, the semicircular frame 121 in accordance with the embodiment of the present invention includes the inner semicircular frame 121a and the outer semicircular frame 121b, which have an H-shaped cross section, although the cross section has different shapes according to the viewing angle. The bearings 160 serve to reduce the generation of friction. One end of each of the bearings 160 is connected to the outer semicircular frame 121b, and the other end of each of the bearings 160 contacts and supports the inner semicircular frame 121a. Therefore, the bearings 160 partially reduces the generation of friction, and allows the weight object rotating unit 120 including the fixed weight object 111 or 112 to be effectively rotated even when a small force is applied to the weight object rotating unit 120.

A method for manufacturing an apparatus for rotating a heavy weight object in accordance with the present invention includes preparing the fixing frame unit 110 to fix the weight object 111 or 112, and fixing the weight object 111 or 112 by adhering the fixing frame unit 110 to at least one surface of the weight object 111 or 112.

The method further includes preparing the weight object rotating unit 120 to accommodate the weight object 111 or 112. Here, the weight object rotating unit 120 includes the semicircular frame 121 and the support frames 122 to rotate the weight object 111 or 112.

The method further includes preparing the weight object/frame support unit 130 formed under the semicircular frame 121. Thus, the weight object/frame support unit 130 supports the semicircular frame 121.

The method further includes preparing the motor/gear unit 140 formed between the weight object rotating unit 120 and the weight object/frame support unit 130. Thus, the motor/gear unit 140 rotates the weight object rotating unit 120 including the fixed weight objects 111 or 112 using the bearings 160. The respective elements of the apparatus were described above with reference to the drawings, and thus the detailed description thereof will be omitted.

Although the embodiment describes that the present invention is applied to an apparatus for rotating a weight object, it will be apparent that the present invention may be applies to an assembly line of production facilities as well as a structural test.

In accordance with the present invention, the apparatus can rotate the weight object when the minimum force is applied to the weight object through the weight object rotating unit having a semicircular shape, such that the center of gravity of the weight object coincides with the center of the weight object rotating unit, by the motor/gear unit.

Further, in accordance with the present invention, the apparatus has a simple structure, compared with a crane or an apparatus using a forklift, thus reducing production costs.

Moreover, in accordance with the present invention, the apparatus, which performs the rotation of the weight object on the weight object/frame support unit, has a minimized radius of rotation and secures the safety, thus being applied to a production and assembly line in a narrow space to produce weight objects or a structural test building.

Although the preferred embodiments of the present invention have been disclosed for illustrative purposes, those skilled in the art will appreciate that various modifications, additions and substitutions are possible.

Therefore, the scope and spirit of the invention is not limited by the above-described embodiment, but is limited only by the accompanying claims and their equivalents.

What is claimed is:

1. An apparatus for rotating a heavy weight object comprising:
a fixing frame unit to fix the weight object;
a weight object rotating unit accommodating the weight object, including a rotatable semicircular frame, and connected to the fixing frame unit;
a weight object/frame support unit formed under the semicircular frame to support the semicircular frame; and
a motor/gear unit formed between the weight object rotating unit and the weight object/frame support unit to rotate the weight object rotating unit using bearings.

2. The apparatus according to claim 1, wherein the fixing frame unit is adhered to at least one surface of the weight object to fix the weight object.

3. The apparatus according to claim 2, wherein the weight object rotating unit includes:
an inner semicircular frame supporting the weight object at the inside to rotate the weight object;
an outer semicircular frame linearly contacting the outer surface of the inner semicircular frame through the medium of the bearings; and
support frames having varied lengths provided between the inner semicircular frame and the fixing frame unit, and connected to the fixing frame unit.

4. The apparatus according to claim 3, wherein the support frames of the weight object rotating unit connect the fixing frame unit to the inner semicircular frame such that the center of gravity of the weight object coincides with the center of the inner semicircular frame.

5. The apparatus according to claim 3, further comprising subsidiary frames formed between the fixing frame unit and the support frames to connect the fixing frame unit and the support frames such that the center of gravity of the weight object coincides with the center of the inner semicircular frame, when the weight object has a large weight.

6. The apparatus according to claim 3, further comprising a plurality of first reinforcing frames to prevent the inner semicircular frame from being separated from the bearings.

7. The apparatus according to claim 3, wherein a plurality of apparatuses comprising a first shaft and a second shaft is provided to support the weight object.

8. The apparatus according to claim 7, further comprising a plurality of second reinforcing frames to connect the first shaft and second shaft.

9. A method for manufacturing an apparatus for rotating a heavy weight object, comprising:
preparing a fixing frame unit to fix the weight object;
preparing a weight object rotating unit accommodating the weight object, including a rotatable semicircular frame, and connecting the weight object rotating unit to the fixing frame unit;
preparing a weight object/frame support unit formed under the semicircular frame, and supporting the semicircular frame through weight object/frame support unit; and
preparing a motor/gear unit formed between the weight object rotating unit and the weight object/frame support unit, and rotating the weight object rotating unit using bearings through the motor/gear unit.

10. The method according to claim 9, wherein in the preparation of the fixing frame unit, the fixing frame unit is adhered to at least one surface of the weight object to fix the weight object.

11. The method according to claim 10, wherein the preparation of the weight object rotating unit includes:
supporting the weight object at the inside through an inner semicircular frame to rotate the weight object;
causing an outer semicircular frame to linearly contact the outer surface of the inner semicircular frame through the medium of the bearings; and
connecting support frames having varied lengths, provided between the inner semicircular frame and the fixing frame unit, to the fixing frame unit.

12. The method according to claim 11, wherein in the preparation of the weight object rotating unit, the support frames of the weight object rotating unit connect the fixing frame unit to the inner semicircular frame such that the center of gravity of the weight object coincides with the center of the inner semicircular frame.

13. The method according to claim 11, further comprising preparing subsidiary frames between the fixing frame unit and the support frames to connect the fixing frame unit and the support frames such that the center of gravity of the weight object coincides with the center of the inner semicircular frame, when the weight object has a large weight.

14. The method according to claim 11, further comprising preparing first reinforcing frames, and fixing the first reinforcing frames to prevent the inner semicircular frame from being separated from the bearings.

15. The method according to claim 11, further comprising preparing second reinforcing frames when a plurality of apparatuses comprising a first shaft and a second shaft is provided to support the weight object, and connecting the first shaft and second shaft through the second reinforcing frames.
